(19) United States
(12) Patent Application Publication
(10) Pub. No.: US 2007/0030780 A1
(43) Pub. Date: Feb. 8, 2007

(54) System and method of estimating the tangential tilt of an optical data carrier...

(76) Inventors: Alexander Padiy, Eindhoven (NL); Johannes Wilhelmus Maria Bergmans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,972

(22) PCT Filed: May 7, 2004
(86) PCT No.: PCT/IB04/01599

§ 371 Date: Nov. 17, 2005

(30) Foreign Application Priority Data
May 20, 2003 (EP) 03291193.5

(51) Int. Cl. G11B 7/00

(52) U.S. Cl. 369/53.19

(57) ABSTRACT

The invention relates to a system and a method of estimating the tangential tilt of an optical data carrier (302) intended to store a primary data signal (301), said method comprising a cross-correlating step for correlating a first data signal (m) derived from a readout data signal (z) with a second data signal (w) derived from a data decision signal (DDS), said readout data signal (z) being derived from said primary data signal (301). Use: Tangential tilt estimation

### FIELD OF THE INVENTION

The invention relates to a system and a method of estimating the tangential tilt of an optical data carrier.

The present invention is applicable in the field of optical or magneto-optical disc systems.

### BACKGROUND OF THE INVENTION

Disc drive systems are designated for storing information onto a disc-shaped storage medium or reading information from such a disc-shaped storage medium. In such systems, the disc is rotated and a write/read head is moved radially with respect to the rotating disc.

An optical storage disc comprises at least one track, either in the form of a continuous spiral or in the form of multiple concentric circles, of storage space where information may be stored. Optical discs may be of the read-only type, where information is recorded during manufacture, which data can only be read by a user. The optical storage disc may also be of a writable type, where information may be stored by a user.

For writing information in the storage space of the optical storage disc, or for reading information from the disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc are commonly known, it is not necessary here to describe this technology in more detail.

For rotating the optical disc, an optical disc drive typically comprises a motor, which drives a hub engaging a central portion of the optical disc. Usually, the motor is implemented as a spindle motor, and the motor-driven hub may be arranged directly on the spindle axle of the motor.

For optically scanning the rotating disc, an optical disc drive comprises a light beam generator device (typically a laser diode), an objective lens for focusing the light beam in a focal spot on the disc, and an optical detector for receiving the reflected light reflected from the disc and for generating an electrical detector output signal.

During operation, the light beam should remain focussed on the disc. To this end, the objective lens is arranged so as to be axially displaceable, and the optical disc drive comprises focal actuator means for controlling the axial position of the objective lens. Furthermore, the focal spot should remain aligned with a track or should be capable of being positioned with respect to a new track. To this end, at least the objective lens is mounted so as to be radially displaceable, and the optical disc drive comprises radial actuator means for controlling the radial position of the objective lens.

More particularly, the optical disc drive comprises a sledge, which is displaceably guided with respect to a disc drive frame, which frame also carries the spindle motor for rotating the disc. The travel course of the sledge is arranged substantially radially with respect to the disc, and the sledge can be displaced over a range substantially corresponding to the range from an inner track radius to an outer track radius. Said radial actuator means comprise a controllable sledge drive, for instance comprising a linear motor, a stepper motor, or a worm gear motor.

The displacement of the sledge is intended for roughly positioning the optical lens. For fine-tuning the position of the optical lens, the optical disc drive comprises a lens platform which carries the objective lens and which is displaceably mounted with respect to said sledge. The displacement range of the platform with respect to the sledge is relatively small but the positioning accuracy of the platform with respect to the sledge is greater than the positioning accuracy of the sledge with respect to the frame.

In many disc drives, the orientation of the objective lens is fixed, i.e. its axis is directed parallel to the rotation axis of the disc. In some disc drives, the objective lens is pivotably mounted, such that its axis can enclose an angle with the rotation axis of the disc. Usually, this is implemented by making the platform pivotable with respect to the sledge.

It is a general desire to increase the storage capacity of a record medium. One way of fulfilling this desire is to increase the storage density. To this end, optical scanning systems have been developed wherein the objective lens has a relatively high numerical aperture (NA). One problem involved in such optical systems is the increased sensitivity to tilt of the optical disc. Tilt of the optical disc can be defined as a situation where the storage layer of the optical disc, at the location of the focal spot, is not exactly perpendicular to the optical axis. Tilt may be caused by the optical disc being tilted as a whole, but is usually caused by the optical disc being warped, and as a consequence the amount of tilt depends on the location on the disc.

As depicted in FIG. 1, the tilt may have a radial component and a tangential component. The radial component (radial tilt) is the component β of the deviation in a plane oriented transversely to the track to be read (i.e. along the radial direction R) and transversely to the data carrier, while the tangential component (tangential tilt) is defined as the component a of the deviation in a plane oriented parallel to the track (i.e. along the tangential direction T) to be read and transversely to the data carrier.

FIG. 2 illustrates the laser beam incident on an optical disc having no tilt and optical discs having a radial and a tangential tilt. If the disc is not tilted, the optical beam 206 remains focused on the track 201. If the disc has radial or tangential tilt which leads to comatic aberration, the optical beam is no longer focused on the tracks 202 and 203 but has a tail 204 and 205 respectively.

As a consequence, it is necessary in an optical disk system, which uses a short wavelength laser diode and a high numerical aperture objective lens, to detect and correct the disc tilt, because the resulting comatic aberration deteriorates the read and write performance, and the tilt margin becomes narrower.

The tangential tilt of an optical disc can be compensated by known optical/mechanical solutions, such as a method using a three-dimensional actuator for the tangential tilt compensation, from a tangential tilt signal delivered by a tilt sensor. The quality of the tilt compensation is directly linked to the accuracy of the tilt signal.

There is thus a need for estimating accurately the tangential tilt of an optical data carrier.

The patent application U.S. Pat. No. 6,525,332 discloses a method for estimating the tangential tilt of an optical data carrier.

This known method leads to limitations since specific mechanic and optical elements are required. The corresponding drive is thus of considerable size, easily damageable, and expensive.

### OBJECT AND SUMMARY OF THE INVENTION

It is an object of the invention to propose an improved method of tangential tilt estimation of an optical data carrier.

For estimating the tangential tilt a of an optical data carrier intended to store a primary data signal, the method according to the invention comprises a cross-correlating step for correlating a first data signal derived from a readout data signal with a second data signal derived from a data decision signal, said readout data signal being derived from said primary data signal.

The tangential tilt estimation according to the invention is based on the fact that, when the tangential tilt is present, a side lobe appears on one side of the time-domain channel response of the readout channel. The side lobe is also visible in the partial derivative of the time-domain channel response of the readout channel. The greater the value of tilt, the more pronounced the side lobe becomes.

This is a solution based only on signal processing which avoids drawbacks of the prior art method.

This method is robust since the proposed coefficients of the filter lead to a low sensitivity to timing errors, DC offsets, and write asymmetries.

Moreover, this method of tilt estimation is not sensitive to the variation of the time sampling of the primary data signal stored on the optical disc, and this method may even be applied asynchronously with respect to the bit clock, assuming that the frequency mismatch is limited. As a consequence, this method works well even if the sampling times are slowly time-varying.

The invention also relates to a system for estimating the tangential tilt of an optical data carrier intended to store a primary data signal, said system comprising processing means for implementing the steps of the method according to the invention.

The invention also relates to a computer program comprising code instructions for implementing the steps of the method according to the invention.

The invention also relates to a signal carrying a tangential tilt measure reflecting the technical characteristics of the method according to the invention.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 illustrates a radial tilt and a tangential tilt in a optical data carrier, FIG. 2 illustrates the comatic aberration of an optical spot on an optical data carrier,

FIG. 3A and FIG. 3B model the main processing steps for reading and retrieving a primary data stored on an optical data carrier,

FIG. 4 illustrates the partial derivative of the time-domain channel response of a readout channel of an optical data reader.

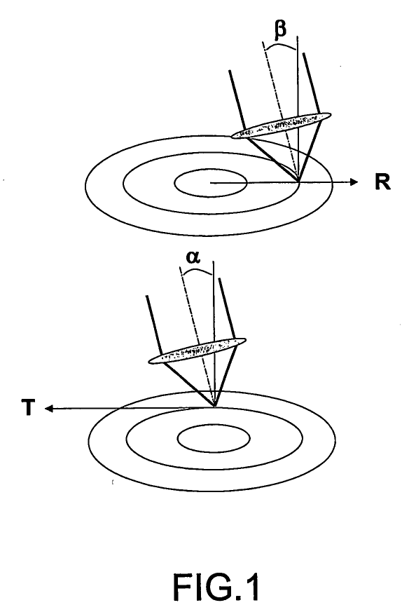

### DETAILED DESCRIPTION OF THE INVENTION

The tilt estimation according to the invention is given based on the example of the DVD+RW (Digital Versatile Disc+ReWritable) system, but the invention also applies to other optical readout systems.

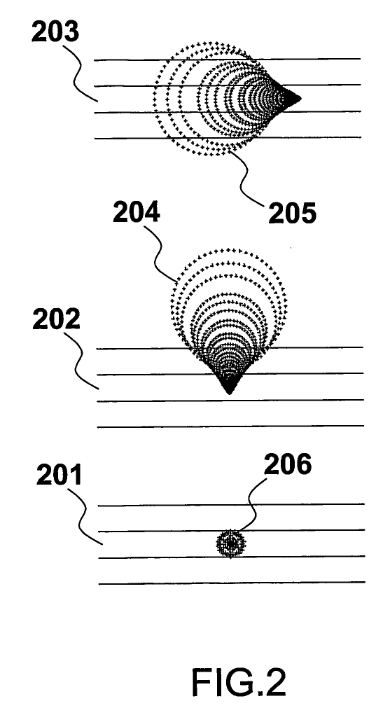

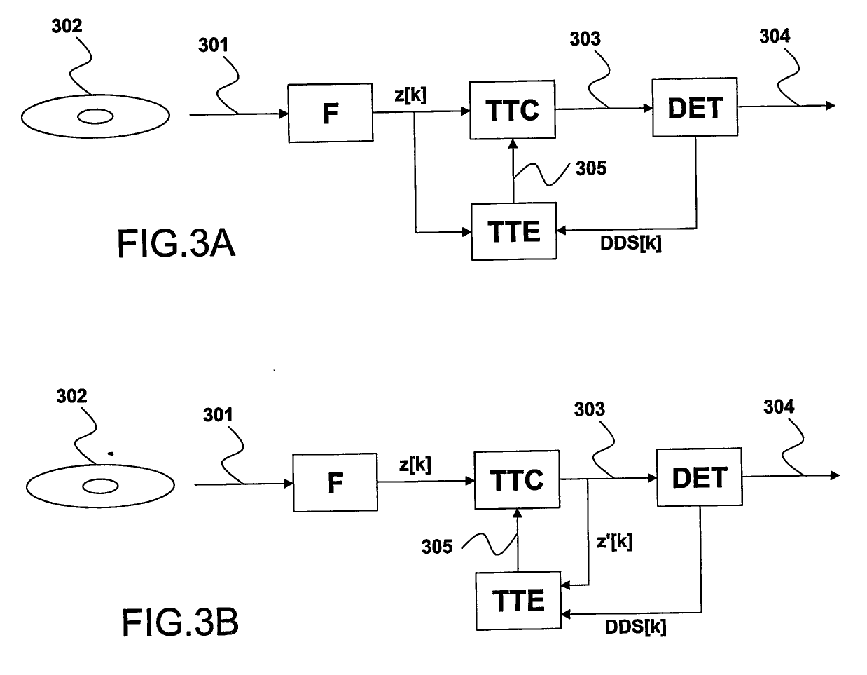

FIG. 3A and FIG. 3B model the main processing steps for reading and retrieving a primary data 301 stored on an optical data carrier 302.

The readout channel response of a DVD+RW system can usually be approximated by a linear filter F which can be estimated experimentally by looking at the read-out data signal z[k] when the stored primary data signal is known or can be reliably detected. The read-out data signal z[k] can be represented as a convolution of the impulse response of said linear filter F with the primary data signal 301 stored on the optical data carrier.

A tangential tilt correction circuit (TTC) receives the readout signal z[k], and generates an output data signal 303 in which the effect of the tangential tilt is significantly reduced. The TTC may correspond to a FIR (Finite Impulse Response) having coefficients adapted to the value of the tangential tilt signal 305 generated by the tangential tilt estimation step TTE.

Once corrected by the TTC, the output signal 303 is fed through a bit detector DET for forcing the level of bits in signal 303 at integer levels. The bit detector generates the output data signal 304, which corresponds theoretically to the primary data signal stored on the optical data carrier.

The primary data signal is stored on the optical data carrier in the form of marks or spaces of specific lengths. For ROM (Read Only Memory) media, marks (i.e. pits) are depressions of the recording layer, while spaces (i.e. lands) are parts of the recording layer itself. For phase-change (PC) media, marks are amorphous areas in a polycrystalline surrounding, the surrounding itself representing the spaces of the PC recording layer. The term “run” is used to refer to a recorded domain, and the term “runlength” refers to the length of a run in bit intervals. The digital data are coded before being stored on disc. Coded data are called channel data, and usually conform to runlength-limited (RLL) modulation codes. RLL codes are characterized by a D and a K constraint. These constraints signify that the shortest allowable domain recorded on disc comprises D+1 channel bit intervals, while the longest domain comprises K+1 channel bit intervals. For example, D=2 and K=10 RLL codes are used in the DVD standard. A domain comprising m channel bit-intervals is denoted by Iₙ, with n being an integer. Both user and channel sequences are assumed to take values from {−1,1}.

Optical read-out may be viewed as a compound process consisting of optical storage followed by optical data retrieval. A commonly used method of characterizing the storage process is in the form of a (binary) Pulse Amplitude Modulation (PAM) model: a basic pulse shape (usually a rectangular pulse) is modulated in amplitude by the channel bits, and the resulting waveform is then stored on the disc. Thus, a recorded domain comprising n channel bit intervals is represented by n consecutive pulses adjacent to each other. If one puts a threshold at zero to distinguish between pits and lands, then all runs of the same runlength have equal duration (Iₙ pits have equal length with Iₙ lands). Therefore, according to the binary PAM model, all domains of equal runlength occupy equal areas on the disc.

The binary-PAM scheme is simple, but has certain features that deviate from optical storage reality, such as the model's abrupt transitions between pits and lands. In reality, mastered pits (in ROM case) have smooth edges which eventually settle at the bottom of the recording layer surface, usually at smaller slopes than those predicted by the PAM model. Moreover, the PAM model's fixed pulse width is not generally accurate for channel modelling. For example, a possible problem arises when a short pit (e.g an I₃ in DVD) is located between two long lands. In that case, the replay signal corresponding to the short pit can be significantly distorted in amplitude, and as a result, it may be misinterpreted as a bit pattern comprising fewer clock cycles after slicing. For example, an I₃-pit may be detected as an I₂-pit, due to an amplitude shift of one of its outer samples above the slicer level. The amplitude distortion of the replay signal is due to the finite resolution of the laser beam, which introduces inter-symbol interference. In order to compensate for this phenomenon, one should aim at a maximum modulation of the shortest run, and this is accomplished by making the pits wider (measured in the direction perpendicular to the tracks), via an increase in the laser power of the laser beam recorder used during the mastering procedure. Therefore, at the same time, the pits are made longer (direction parallel to the tracks) than in the nominal “symmetrical” case. This procedure results in bit-duration (and amplitude) inequalities between pits and lands of nominally the same length in the stored signal. The extent of these inequalities is measured by a quantity known as signal asymmetry (ASM) and is defined as follows:

$$ASM = \frac{\frac{{I}_{k + 1}^{H} + {I}_{k + 1}^{L}}{2} - \frac{{I}_{d + 1}^{H} + {I}_{d + 1}^{L}}{2}}{{I}_{k + 1}^{H} - {I}_{k + 1}^{L}} \qquad Eq . 1$$

where Iₖ₊₁^{H} and Iₖ₊₁^{L} denote the high-peak (land) and low-peak (pit) amplitude values of the longest run (I₁₄ in DVD),
where Iₖ₊₁^{L} and Iₖ₊₁^{L} denote the high-peak and low-peak amplitude values of the shortest possible run (I₃ in DVD).

Note that the longest run in the DVD format is an I₁₄ and not an I₁₁, as the k=10 constraint would imply. This is due to the synchronization patterns, which do not correspond to coded user data (and thus do not necessarily follow the code constraints), and which contain I₁₄ runs.

The tangential tilt estimation TTE according to the invention is based on the fact that a side lobe appears on one side of the time-domain channel response of the readout channel when the tangential tilt is present. The greater the value of tilt, the more pronounced the side lobe becomes.

Since the side lobe is also visible in the partial derivative g[k] of the time-domain channel response of the readout channel, k being an integer indicating the rank of the data samples, the side lobe of said partial derivative g[k] is modelled by a filter c[k] defined by a set of coefficients.

The tangential tilt value α may thus be derived from the following equivalent relations:
α={z[k]} corr {c[k] conv DDS[k]} Eq.2
α={c[−k] conv z[k]} corr {DDS[k]} Eq.3

where conv denotes the convolution operation,
corr denotes the correlation operation,
DDS[k] denotes a decision data signal corresponding to the primary data signal.
   The above two relations are equivalent since the order of convolution and correlation operations may be reversed because of their linearity.

Alternatively, instead of performing the tilt estimation from the read-out data signal z[k], it may be performed from data signal z′[k] referred to as 303 generated at the output of the TTC as depicted in FIG. 3B.

More generally, the data signal z[k] in Eq.2 and Eq.3 may be replaced by any data signal zz[k] defined by zz[k]=z[k]+q[k] under the condition that:
{q[k]} corr {c[k] conv DDS[k]}=0 Eq.4

For taking into account the effect of asymmetry in the write channel, the method of tangential tilt estimation uses a decision data signal DDS[k] corresponding to the primary data signal.

Decision data signal DDS[k] may denote binary bit decisions from the alphabet a[k]={−1,+1}. The decision data signal a[k] is for example generated by the bit detector of the read channel usually located at the output of reading optical system.

Alternatively, DDS[k] may denote ternary bit decisions from the alphabet b[k]={1, B, +1}, where B is a coefficient derived from a[k] and on an estimate of the disc asymmetry ASM.

The side lobe related part of the partial derivative g[k] of the channel response with respect to the tangential tilt angle is modelled, for example, by means of an anti-symmetric FIR filter c[k] comprising two side lobes and formed by the following set of coefficients:
c[k]=[−A−B 0 0 0 . . . 0 0 0+B+A]

where A and B are non-zero filter coefficients, and k is the rank of coefficients.

A plurality of zeros are included in the central part of c[k] in order to achieve orthogonality with the time-derivative of the readout channel response, for eliminating cross-talk with the timing recovery subsystem usually referred to as SRC-PLL and used in optical data readers for re-sampling the readout data signal. Coefficients of filter c[k] are thus chosen so as to define a filter kernel orthogonal to the time-derivative of the readout channel response.

Since the tangential tilt estimation is performed in looking at the presence (i.e. at the magnitude) of the component c[k] in the readout channel response, the sections [−A −B] and [+B +A] may be placed in the filter c[k] at the positions of the side lobes appear in the readout channel response, and chose coefficients A and B to be of the same sign. The simplest practical choice for the coefficients A and B is A=1 and B=1.

In the case of DVD+RW system, the sections [−A −B] and [+B +A] in the filter c[k] should be advantageously separated by 11 zeros assuming that the system works at the bit-synchronous clock, i.e. assuming the incoming bit-asynchronous readout data into the readout data signal are synchronized with the primary data bits stored on the optical data carrier.

The tilt estimation may also be applied in a different clock domain. To this end, the filter c[k] should be adjusted accordingly as a function of the over-sampling/under-sampling rate. The simplest solution is to adjust only the number of zeros in the middle of c[k], which works fine if the difference in clock speed is relatively small.

To facilitate the notation, the filter c[k] may be decomposed in two parts c1[k] and c2[k] such that:
c[k]=c1[k] conv c2[k] Eq.5

The filters c1[k] and c2[k] are chosen such that the coefficients of the superposition filter c[k]={c1[k] conv c2[k]} model a number of anti-symmetric lobes arising in the channel response due to tangential tilt, and that the filter kernel of the superposition filter c[k]]={c1[k] conv c2[k]} is orthogonal to the time-derivative of the channel response.

Then, considering the linearity of the convolution and correlation operators, instead of the 2 formulae Eq.2 and Eq.3, the following general relations may be used:
α={c1[−k] conv z[k]} corr {c2[k] conv DDS[k]} Eq.6

where c1=[1] and c2[k]=c[k] in Eq.2

where c1[k]=c[k] and c2=[1] in Eq.3

The method of estimating the tangential tilt according to the invention thus comprises a cross-correlating step for correlating a first data signal m[k] defined by m[k]=c1[−k] conv z[k] derived from the readout signal z[k], with a second data signal w[k] defined by w[k]=c2[k] conv DDS[k] derived from a data decision signal DDS[k].

The first data signal m[k] may for example derive from:

a) A filtering step: In that case, m[k]=c1[−k] conv z[k], where c1[k]=1 if Eq.2 applies.
b) A filtering step and an addition step of another signal q[k]. In that case, m[k]={c1[−k] conv z[k]}+q[k], where q[k] is any signal verifying q[k] corr w[k]=0 for the signal w[k] defined below. In particular, q[k]=0.
c) A non-linear operation like a clipping step. In that case, m[k]=sign({c1[−k] conv DDS[k]}+q[k]).
   The second data signal w[k] may for example derive from:
d) A filtering step: In that case, w[k]=c2[k] conv DDS[k], where c2[k]=1 if Eq.3 applies.
e) A filtering step and an addition step of another signal p[k]. In that case, w[k]={c2[k] conv DDS[k]}+p[k], where p[k] is any signal verifying p[k] corr m[k]=0 for the signal m[k] defined above. In particular, p[k]=0.
f) A non-linear operation like a clipping step. In that case, w[k]=sign({c2[k] conv DDS[k]}+p[k]).

The output of tilt estimation algorithms described above is proportional to the magnitude of the tangential tilt. However, the proportionality constant between the output of tilt estimation algorithms and the actual tilt magnitude should be calibrated in advance. The calibration is less important if the tilt estimation is performed from the tilt-corrected waveform samples as depicted in the scheme of FIG. 3B.

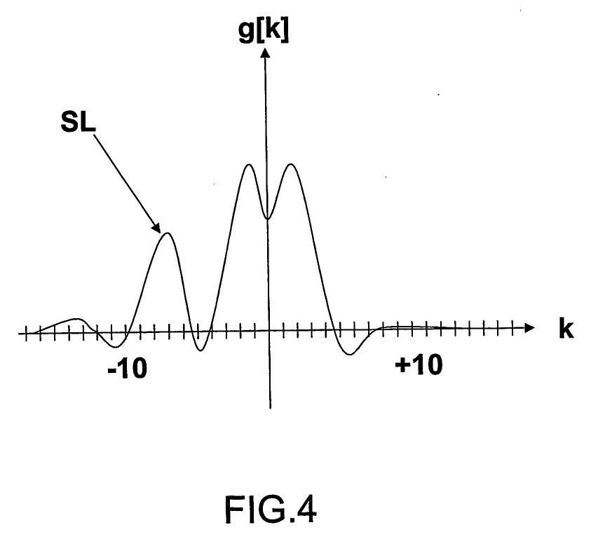

FIG. 4 illustrates the partial derivative g[k] of the time-domain channel response of a readout channel of the DVD+RW channel response for a given value of the tangential tilt α. The side lobe modelled by filter c[k] is referred to as SL.

The situation remains qualitatively the same for other optical drive systems: only the distance from the side lobe to the central lobe changes in dependence on the optical spot resolution.

The method according to the invention may be implemented by means of a computer program comprising code instructions for implementing the various processing steps.

In an optical data carrier reader and/or writer, such a method may be implemented in a system (e.g. an electronic module or an integrated circuit) for estimating the tangential tilt of an optical data carrier intended to store a primary data signal, said system comprising processing means for cross-correlating a first data signal (m) derived from a readout data signal (z) with a second data signal (w) derived from a data decision signal (DDS), said readout data signal (z) being derived from said primary data signal (301). Said processing means may correspond to code instructions stored in a memory and executed by a signal processor.

The invention also relates to a signal carrying a tangential tilt measure reflecting the technical characteristics of the method according to the invention. Said signal derives from the cross-correlation between a first data signal (m) derived from a readout data signal (z) and a second data signal (w) derived from a data decision signal (DDS), said readout data signal (z) being derived from said primary data signal (301).

The word “comprise” does not exclude the presence of other elements than those listed in the claims.

1. Method of estimating the tangential tilt of an optical data carrier (302) intended to store a primary data signal (301), said method comprising a cross-correlating step for correlating a first data signal (m) derived from a readout data signal (z) with a second data signal (w) derived from a data decision signal (DDS), said readout data signal (z) being derived from said primary data signal (301).

2. Method as claimed in claim 1 where:
said first data signal (m) corresponds to said readout data signal (z),
said second data signal (w) derives from a convolution step between said data decision signal (DDS) and the impulse response of a filter (c2) defined by a set of coefficients.

3. Method as claimed in claim 1, wherein:
said first data signal (m) derives from a convolution step between said readout data signal (z) and the impulse response of a filter (c1) defined by a set of coefficients,
said second data signal (w) corresponds to said data decision signal (DDS).

4. Method as claimed in claim 2, wherein said filter (c1, c2) is of the FIR or IIR type, or a combination thereof.

5. Method as claimed in claim 4, wherein said coefficients form two anti-symmetric side lobes.

6. Method as claimed in claim 5, wherein said coefficients define a filter kernel orthogonal to the time-derivative of the channel response generating said readout data signal.

7. Method as claimed in claim 6, wherein said coefficients are adjusted as a function of the sampling rate.

8. System for estimating the tangential tilt of an optical data carrier (302) intended to store a primary data signal (301), said system comprising processing means for cross-correlating a first data signal (m) derived from a readout data signal (z) with a second data signal (w) derived from a data decision signal (DDS), said readout data signal (z) being derived from said primary data signal (301).

9. A computer program comprising code instructions for implementing the steps of the method as claimed in claim 1.

10. Signal carrying a tangential tilt measure of an optical data carrier (302) intended to store a primary data signal (301), said signal deriving from the cross-correlation between a first data signal (m) derived from a readout data signal (z) and a second data signal (w) derived from a data decision signal (DDS), said readout data signal (z) being derived from said primary data signal (301).
